(19) United States
(12) Patent Application Publication
(10) Pub. No.: US 2016/0302450 A1
(43) Pub. Date: Oct. 20, 2016

(54) ANIMAL FEED SUPPLEMENT COMPOSITIONS AND METHODS

(71) Applicant: Milk Specialties Company DBA Milk Specialties Global, Eden Prairie, MN (US)

(72) Inventors: Jacob John Albrecht, St. Paul, MN (US); Charles Gordon Soderholm, Mankato, MN (US)

(21) Appl. No.: 15/130,123

(22) Filed: Apr. 15, 2016

Related U.S. Application Data
(60) Provisional application No. 62/148,464, filed on Apr. 16, 2015.

(51) Int. Cl. A23K 40/30; A23K 20/158; A23K 20/22

(52) U.S. Cl. CPC A23K 40/30; A23K 20/22; A23K 20/158

(57) ABSTRACT

This disclosure describes an animal feed nutritional supplement composition, methods of making the composition, and methods of using the composition. Generally, the animal feed nutritional supplement includes a core material at least partially coated with free fatty acid. Typically, the animal feed supplement composition melts when heated.

### CROSS-REFERENCE TO RELATED APPLICATION

This application claims priority to U.S. Provisional Patent Application Ser. No. 62/148,464, filed Apr. 16, 2015, which is incorporated herein by reference.

### SUMMARY

This disclosure describes, in one aspect, an animal feed nutritional supplement composition. Generally, the animal feed nutritional supplement includes a core material at least partially coated with free fatty acid. The core material generally includes a salt of a caustic mineral. In some embodiments, the salt of a caustic mineral can be potassium carbonate. Typically, the animal feed supplement composition melts when heated.

In another aspect, this disclosure describes a method of making an animal feed supplement composition. Generally, the method includes providing a core material in a rotating drum, melting a mixture of free fatty acids, spraying the melted free fatty acid mixture on the core, and allowing the free fatty acid to cool.

In some cases, the method can reduce the hygroscopy of the core material. In some embodiments, the method can reduce the reactivity of the core material.

The above summary of the present invention is not intended to describe each disclosed embodiment or every implementation of the present invention. The description that follows more particularly exemplifies illustrative embodiments. In several places throughout the application, guidance is provided through lists of examples, which examples can be used in various combinations. In each instance, the recited list serves only as a representative group and should not be interpreted as an exclusive list.

### BRIEF DESCRIPTION OF THE FIGURES

FIG. 1. A graph of cow dry matter intake of a total mixed ration containing fat-coated potassium carbonate (EB-K) compared to a mixture of fat and potassium carbonate (Control).

FIG. 2. A graph of milk production dairy cows consuming fat-coated potassium carbonate (EBK) compared to milk production dairy cows consuming a mixture of fat and potassium carbonate (EB-DCAD). Vertical lines indicate the beginning and end of the experimental feeding period.

FIG. 3. A graph of milk fat % of milk from dairy cows consuming fat-coated potassium carbonate (EBK) compared to milk fat % OF milk FROM dairy cows consuming a mixture of fat and potassium carbonate (EB-DCAD). Vertical lines indicate the beginning and end of the experimental feeding period.

FIG. 4. Photographs of potassium carbonate products. (A) DCAD Plus (Arm & Hammer Animal Nutrition, Church & Dwight Co., Inc., Ewing, N.J.) is granular (left panel) before being stored in a foil-tented beaker in a heated water bath at 100° F. for two days. After the two days, DCAD Plus is wet and clumps (right panel). (B) Fat-coated K₂CO₂ (EB-K) is granular before identical treatment (left panel) and remains granular after treatment (right panel).

FIG. 5. Photographs of potassium carbonate products. (A) A mixture of uncoated potassium carbonate and prilled free fatty acid (90% mixture, 10% water, by weight) after storage for one week at 120° F. (B) Free fatty acid-coated potassium carbonate (90% EB-K, 10% water, by weight) after storage for one week at 120° F.

### DETAILED DESCRIPTION OF ILLUSTRATIVE EMBODIMENTS

This disclosure provides an animal feed nutritional supplement and methods involving the animal feed supplement. Generally, the animal feed supplement includes a core material that is at least partially coated with a mixture of free fatty acids. The core material generally includes a salt of a nutritional mineral. The supplement therefore provides the nutritional mineral and free fatty acid (as a nutritional energy source) in a formulation that possesses desirable handling properties.

Supplementing the feed of dairy cows with potassium can provide certain benefits, particularly during the summer months when dairy cows can suffer from heat stress. For example, potassium is an abundant mineral in milk and is excreted in sweat, but is often present on low amounts in present typical diets (composed mostly of corn silage) compared to historical diets (composed mostly of alfalfa hay). Potassium helps increase the dietary cation-anion difference (DCAD), which can improve lactational performance, as described in U.S. Pat. Nos. 6,299,913 and 6,485,765. Dairy cows also can benefit from supplemental carbonate, which is an alkalizing ion that helps increase rumen pH and thereby lower the risk of ruminal acidosis. Potassium carbonate can act as an antacid and reduce acidity in the gut of ruminants. This reduced acidity in the gut can improve lactational performance of dairy cows. Potassium carbonate can, however, be difficult to handle in the feed mill and on the farm due to its hygroscopic and caustic nature.

Supplementing the feed of dairy cows with fat also can provide certain benefits. Dairy cows that are experiencing heat stress typically ingest less feed, which can result in the dairy cows failing to meet the total energy demand of lactation and maintenance unless the energy density of the diet is increased. Feeding a dairy cow too much unsaturated fat is toxic to the fiber digestion bacteria of the rumen, causing reduced feed intake and milk fat depression. However, feeding a highly saturated free fatty acid product is ruminally inert, does not decrease the feed intake of the dairy cow, increases the energy density of the diet, and therefore promotes meeting the total energy demand of lactation and maintenance.

This disclosure describes a single dietary supplement for animal feed that provides both saturated free fatty acids and potassium carbonate in a concentration of 20-50% and in a form that is nutrient dense (i.e., fat residues and potassium carbonate alone with limited fillers).

An initial investigation involved preparing a composition that included 1% potassium. Free fatty acid (98%, weight percent of total composition) was heated to 200° F. and combined with potassium carbonate (2%) in a beaker. This combination contained too little potassium to be a commercially relevant animal nutritional product, but was investigated to determine how the free fatty acid and potassium carbonate would react when heated. The product was a liquid that could be pumped through a line and would form a prill when sprayed into a chilled spray tower.

A second investigation involved preparing a 3% potassium composition by combining free fatty acid (94%, weight percent of total composition) heated to 200° F. with potassium carbonate (6%, weight percent of total composition) in a beaker. As with the initial investigation, this level of potassium was less than desired for an animal nutritional product, but was investigated to determine how the free fatty acid and potassium carbonate would react when combined at a slightly higher concentration of potassium. The product was more viscous than the 1% potassium composition, but was still a liquid that could be pumped through a line and would form a prill when sprayed into a chilled spray tower.

A third investigation involved preparing a composition that included 6% potassium. The composition was prepared by combining free fatty acid (88%, weight percent of total composition) heated to 200° F. with potassium carbonate (12%, weight percent of total composition) in a beaker. The product was much more viscous than the 3% potassium composition of the second investigation described above. The viscosity made it difficult to pump the liquid through a line using readily-available equipment. The product was, however, capable of forming a prill when sprayed into a chilled spray tower.

A fourth investigation involved preparing a composition that included 10% potassium. The composition was prepared by combining free fatty acid (80%, weight percent of total composition) heated to 200° F. with potassium carbonate (20%, weight percent of total composition) in a beaker. The product was excessively viscous that turned into a hard soap upon cooling. The soap, when heated, would not melt.

The free fatty acid mix, when heated to 200° F., which is necessary to melt the free fatty acid mix and allow pumping and/or spraying the melted fat, reacted with high levels of potassium carbonate to yield a product that had unmanageable handling characteristics. To produce a free fatty acid-potassium carbonate animal nutritional supplement with a greater potassium content, one can use a different approach for comingling the free fatty acid and potassium carbonate.

Rather than comingling the materials in a beaker or tank, this disclosure describes a method—and resulting composition—that involves comingling the materials by pan coating in a drum. The materials and temperatures used to mix the free fatty acid and potassium carbonate were the same as in the fourth investigation describe above. Prior to undertaking this approach, it was unclear whether the difference in the comingling approach would alter the reactivity of the free fatty acid and potassium carbonate. Using the pan coating technique, however, caused the liquid free fatty acid to coat the potassium carbonate rather than reacting with the potassium carbonate. The resulting product formed single prills, was palatable to cows, provided the energy needed by lactating cows, alkalized when mixed with water, and had desirable handling characteristics—i.e., an acceptably low level of hygroscopy in warm and humid conditions.

Saturated free fatty acid was heated in a tank to 200° F., pumped through lines, and sprayed through nozzles into a rotating drum containing potassium carbonate. The sprayed free fatty acid coats, rather than reacts with, the potassium carbonate to produce a prilled product having a potassium carbonate core with a coating that includes the free fatty acid. As used herein, the terms “coating,” “coated,” and variations thereof refer to a layer of free fatty acid that may be continuous or discontinuous covering at least a portion of the core.

The form of the final product was not intuitive. When one simply mixes saturated free fatty acid, which is acidic, with a nutritionally desirable amount of potassium carbonate, which is basic, at 200° F., the outcome is highly predictable: the saturated free fatty acid and potassium carbonate react and form a fatty acid salt in the form of a solid—i.e., a soap. One would not necessarily expect anything different to happen whenever molten saturated free fatty acid and potassium carbonate come in contact. By comingling the components in the drum, however, the same conditions—i.e., the same dry and liquid ingredients, the same inclusion level, liquid held at the same temperature—produces a dramatically different product.

Thus, this disclosure describes a free fatty acid-mineral composition that generally includes a core that is at least partially coated by a free fatty acid. The core generally includes a salt of a caustic mineral. In some embodiments, the core can include a nutritional mineral such as, for example, potassium. Thus, in some embodiments, the mineral salt can be, for example, potassium carbonate. The composition can be used as a feed ingredient in the ration fed to animals such as, for example, lactating dairy cows. In the context of supplementing the feed of dairy cows, the product can improve the ration buffering capacity, increase supply of potassium during heat stress conditions, and/or balance electrolytes in the ration (i.e., Na⁺, K⁺, and Cl⁻ ratios), any or all of which can improve lactation performance.

While described occasionally herein in the context of an exemplary embodiment in which the core includes potassium carbonate, the core can include any salt of a caustic and/or nutritional mineral. Thus, the core can include any salt of minerals including, for example, potassium or calcium. Similarly, the core can include any salt of the caustic mineral such as, for example, a carbonate salt, a bicarbonate salt, a sulfate salt, or an acetate salt. In various exemplary embodiments, the core can include potassium carbonate, sodium carbonate, or potassium bicarbonate.

The composition can include a minimum amount of mineral that is at least 5% of the total weight of the composition such as, for example, at least 6%, at least 7%, at least 8%, at least 9%, at least 10%, at least 11%, at least 12%, at least 13%, at least 14%, at least 15%, at least 16%, at least 17%, at least 18%, at least 19%, at least 20%, at least 21%, at least 22%, at least 23%, at least 24%, or at least 25%.

The composition can include a maximum amount of mineral that is no more than 40% of the total weight of the composition such as, for example, no more than 30%, no more than 27.5%, no more than 25%, no more than 20%, or no more than 15%.

In some embodiments, the composition can include an amount of mineral that is within a range having endpoints defined by any minimum amount of mineral listed above and any maximum amount of mineral listed above that is greater than the minimum amount of mineral.

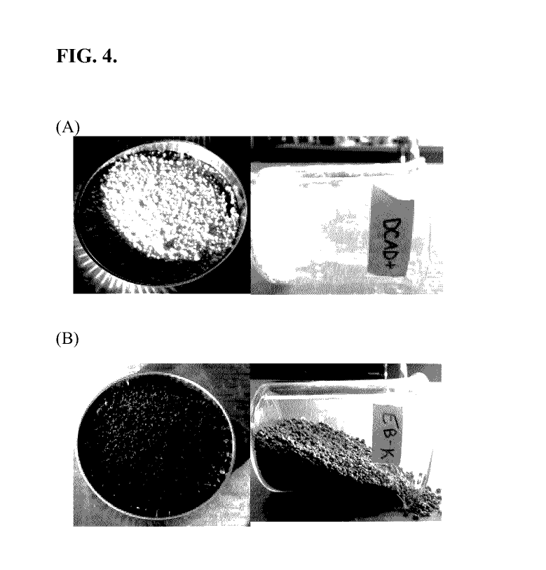

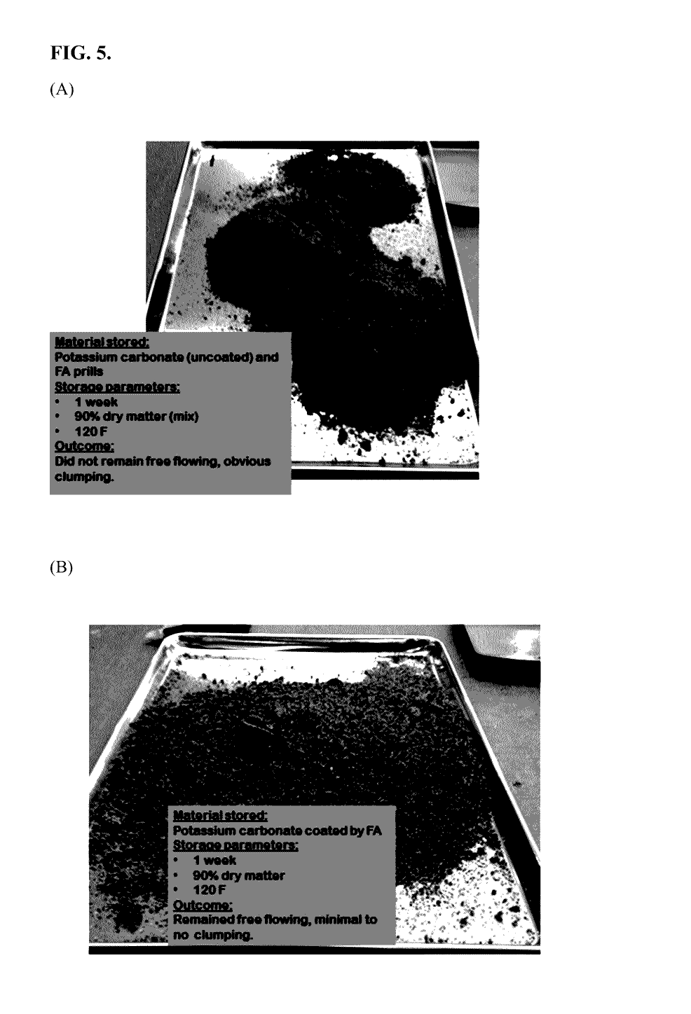

Generally, the composition possesses handling characteristics that make it easier to transport, store, and/or distribute than an uncoated formulation of the mineral salt and/or a mere mixture of free fatty acid and the mineral salt. Exemplary handling characteristics include having less hygroscopic character than uncoated mineral salt compositions. This character is reflected in FIG. 4. FIG. 4A shows a granular non-coated mineral salt composition. After being stored in an environment of approximately 120° F., 100% relative humidity for two days, the composition is visibly clumped. In contrast, FIG. 4B shows a granular fatty acid-coated potassium carbonate composition (11%-14% potassium, by weight) that, when exposed to the same conditions, remains visibly free-flowing and granular. This character is further reflected in FIG. 5. FIG. 5A shows a mixture of uncoated potassium carbonate and prilled free fatty acid (90% mixture, 10% water, by weight) after being stored in a container for one week at 120° F. When the canister was inverted over the pan, much of the dry matter mixture remains clumped, retaining the shape of the container in which the material was stored. In contrast, FIG. 5B shows the character of the EB-K granular fatty acid-coated potassium carbonate composition (again, 90% dry matter, 10% water, by weight) when tested under the same conditions. FIG. 5B shows that the coated potassium carbonate exhibits minimal to no clumping and fails to retain the shape of the container in which the composition was stored.

Another handling characteristic is the reactivity of the composition. For example, it can be advantageous to have a nutritional supplement that does not react with the primary feed composition after being mixed and stored with primary feed composition. Table 1 provides data demonstrating that the reactivity of K₂CO₃ decreases as one increases the amount of free fatty acid in the composition.

TABLE 1

| | | | Time(seconds) to reach a pH |
|---|---|---|---|
| Pass # through | | | of 10 (3.2 g K carbonate |
| pan coating | wt % | wt % | equivalents into 100 mL of |
| drum | K₂CO₃ | K | agitated 38° C. water) |
| 0 | 100% | 55% | 2 |
| 1 | 69% | 38% | 3 |
| 2 | 53% | 29% | 9 |
| 3 | 40% | 22% | 18 |
| 4 | 31% | 17% | 22 |
| 5 | 24% | 13% | 50 |

### Methods

The composition can be used as a dietary animal feed supplement. While described occasionally herein in the context of an exemplary embodiment in which the animal is a lactating dairy cow, the composition can serve as a dietary supplement to other animals such as, for example, other livestock and/or companion animals. Exemplary other animals include, for example, other bovine species such as, for example, bison antelope, sheep, goats, cattle, or oxen.

The composition may be fed to the animal at a minimum feeding rate of at least 0.1% of dry matter intake such as, for example, at least 0.2%, at least 0.3%, at least 0.4%, at least 0.5%, at least 1.0%, at least 1.5%, at least 2.0%, at least 2.5%, at least 3.0%, at least 3.5%, or at least 4.0% of dry matter intake

The composition may be fed to an animal at a maximum feeding rate of no more than 5% of dry matter intake such as, for example, no more than 4.5%, no more than 4.0%, no more than 3.5%, no more than 3.0%, no more than 2.5%, no more than 2.0%, no more than 1.5%, no more than 1.0%, no more than 0.9%, no more than 0.8%, no more than 0.7%, no more than 0.6%, or no more than 0.5% of dry matter intake.

The composition may be fed to the animal at a feeding rate within a range having endpoints defined by any minimum feeding rate listed above and any maximum feeding rate listed above that is greater than the minimum feeding rate. In one exemplary embodiment, the composition may be provided to the animal at a feeding rate that ranges from about 0.1% to about 5% of dry matter intake per day.

In one particular embodiment, the composition may be fed to dairy cows in an amount of from about 0.1 g/day to about 160 g/day.

As used herein, the term “and/or” means one or all of the listed elements or a combination of any two or more of the listed elements; the terms “comprises” and variations thereof do not have a limiting meaning where these terms appear in the description and claims; unless otherwise specified, “a,” “an,” “the,” and “at least one” are used interchangeably and mean one or more than one; and the recitations of numerical ranges by endpoints include all numbers subsumed within that range (e.g., 1 to 5 includes 1, 1.5, 2, 2.75, 3, 3.80, 4, 5, etc.).

In the preceding description, particular embodiments may be described in isolation for clarity. Unless otherwise expressly specified that the features of a particular embodiment are incompatible with the features of another embodiment, certain embodiments can include a combination of compatible features described herein in connection with one or more embodiments.

For any method disclosed herein that includes discrete steps, the steps may be conducted in any feasible order. And, as appropriate, any combination of two or more steps may be conducted simultaneously.

The present invention is illustrated by the following examples. It is to be understood that the particular examples, materials, amounts, and procedures are to be interpreted broadly in accordance with the scope and spirit of the invention as set forth herein.

### EXAMPLES

### Example 1

Saturated free fatty acid (Energy Booster-100, Milk Specialties Co., Eden Prairie, Minn.) is heated in a tank to 200° F. The molten saturated free fatty acid (460 pounds) is pumped through lines and sprayed into a rotating drum, where it comingled with potassium carbonate. The free fatty acid was pumped into the rotating drum having a diameter of 2.5 feet and a length of 8.0 feet. The drum possessed two nozzles that sprayed the molten free fatty acid into the drum at a combined rate of two pounds per minute. The drum possessed eight paddles (2 in.×3 in.) that were evenly spaced along the length of the drum. Drum bed temperatures were maintained at 32° C. to 36° C. The drum was rotated at a rate of 8 RPM.

110 pounds of potassium carbonate (Prince Chemical Corp., Marietta, Ga.) was fed into the drum at a rate of six pounds per minute. Free fatty acid-coated potassium carbonate material exiting the drum was recycled into the feed until all of the fat was sprayed, making about five passes through the drum. The resulting product (EB-K) has potassium carbonate core that is coated with saturated free fatty acid having a composition of 24% K₂CO₃ and 76% free fatty acid, by weight.

### Example 2

### Treatments

Control: Energy Booster-100 (EB-100, Milk Specialties Co., Eden Prairie, Minn.) and free flowing Potassium Carbonate (K₂CO₃) fed at the rate of 1.5% of ration dry matter (DM). Approximately 0.75 lb/cow/day (340 g/cow/d).

EB-K: K₂CO₃ coated with free fatty acids (FFA) fed at the rate of 1.5% of ration DM. Approximately 0.75 lb/cow/day (340 g/cow/d).

### Animals

Ten lactating Holstein dairy cows in mid-lactation to late-lactation were randomly divided into two blocks and assigned to one of the two treatments. Block 1 had six cows, Block 2 had four cows.

### Experimental Design

The study duration was six days, preceded by a day of training. One block of cows was given the treatment sequence of EB, EB-K, EB, EB-K, EB, and EB-K each day, while the other block of cows was given the treatment sequence of EB-K, EB, EB-K, EB, EB-K, and EB for each day. This is a switchback experimental design.

All normal bedding, cow monitoring, manure scrapping followed normal procedures. Regular total mixed ration (TMR) feed was removed and the feed tubs were left empty for one hour. Cows were subsequently fed once daily at 10:00 a.m. or later in the day.

Normal TMR was mixed with EB-100 or the FFA-coated K₂CO₃ to produce the EB and EB-K treatments, respectively. Approximately 35 pounds of each treatment was weighed and placed in the feed tub. Cows were permitted to feed for 10 minutes, the treatments were removed and the remaining amount of each treatment was recorded.

Normal TMR was added to the feed tub for cows to have ad libitum intake for the rest of the day until the next morning. The mixing, feeding, and measuring was repeated over the remaining course of the study according to the schedule shown in Table 2.

TABLE 2
Experimental Schedule.

| Date | Day | Task | Activity |
|---|---|---|---|
| Saturday | −2 | Weigh Cows | Move Cows to WW |
| Sunday | −1 | Feed cows | Training |
| Monday | 1 | Measure Intake | Data collection |
| Tuesday | 2 | Measure Intake | Data collection |
| Wednesday | 3 | Measure Intake | Data collection |
| Thursday | 4 | Measure Intake | Data collection |
| Friday | 5 | Measure Intake | Data collection |
| Saturday | 6 | Measure Intake | Weigh Cows & Return |

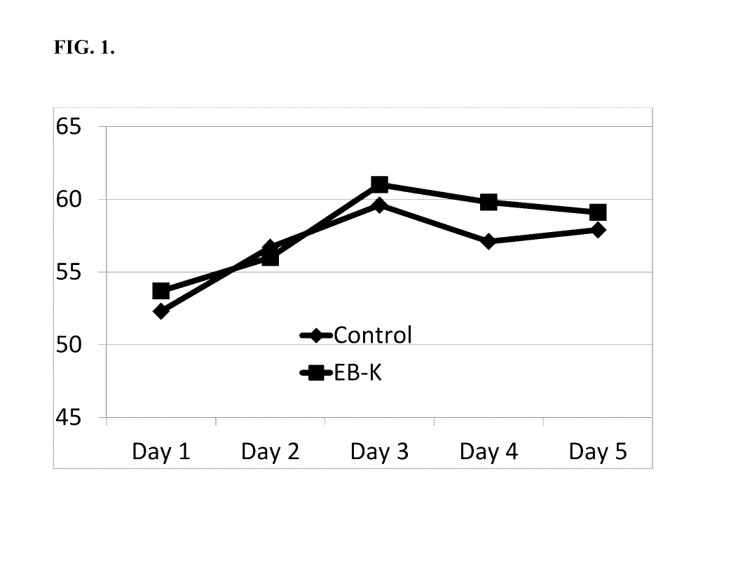

Results are shown in FIG. 1.

### Example 3

### Treatments

EB-hP-K: Energy Booster hP (Milk Specialties Co., Eden Prairie, Minn.) with DCAD PLUS (Arm & Hammer Animal Nutrition, Church & Dwight Co., Inc., Ewing, N.J.).

EB-K: K₂CO₃ coated with free fatty acids (FFA).

### Study Design

Two pens of early lactation cows were used in a 21-day study of milk production. Pen data at the start of the study is shown in Table 3.

TABLE 3

| | Pen A | Pen B |
|---|---|---|
| Number of cows | 264 | 261 |
| Days in milk | 97 | 95 |
| Milk/cow/day (lbs.) | 126.7 | 123.2 |

| | |
|---|---|
| Herd fat test (%) | 3.8 |
| Herd protein (%) | 3.15 |

Pen A was fed 325 lbs/day of EB-hP-K for an approximate feeding amount of 1.25 lb/lb/cow/day. Pen B was fed 325 lbs/day of EB-K for an approximate feeding amount of 1.25 lb/lb/cow/day. For both treatments, the relative amounts of potassium and free fatty acid were the same, delivering at least 4 oz. of K₂CO₃ to each cow per day.

Pen feed intakes were measured and recorded daily. Diets were fed as TMR and all feed offering were weighed for each pen. Refusals were weighed back or estimated each day before daily fresh feed was offered. Weighbacks for each pen were measured daily before the first feeding of fresh TMR. Weighbacks were weighed or estimated through skid steer bucket amounts (full, ¾, ½, ¼, none). A full bucket will be weighed and calibrated if estimation method is used.

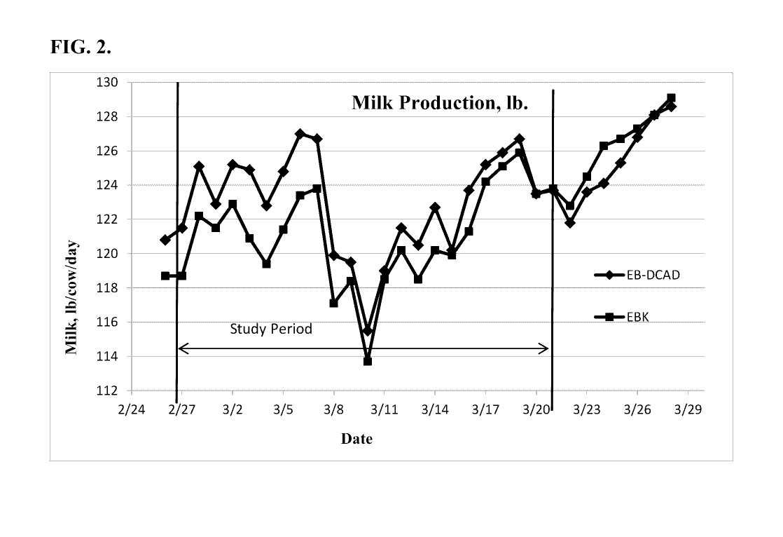

Daily production information for each pen was measured. Cow number, Days in Milk and Daily Milk Production as reported on a daily milk sum sheet (DMSUM) in DairyComp 305 (Valley Agricultural Software, Tulare, Calif.). Results are shown in FIG. 2.

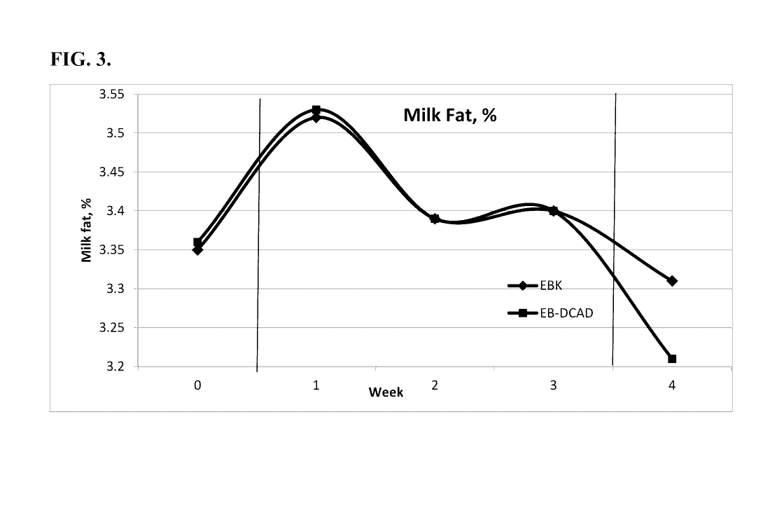

In-line milk samples for each pen were collected during one milking one day each week during the study. Samples were tested for routine milk composition at Minnesota Dairy Herd Improvement Association, Zumbrota, Minn. Milk fat % data are shown in FIG. 3.

The complete disclosure of all patents, patent applications, and publications, and electronically available material cited herein are incorporated by reference in their entirety. In the event that any inconsistency exists between the disclosure of the present application and the disclosure(s) of any document incorporated herein by reference, the disclosure of the present application shall govern. The foregoing detailed description and examples have been given for clarity of understanding only. No unnecessary limitations are to be understood therefrom. The invention is not limited to the exact details shown and described, for variations obvious to one skilled in the art will be included within the invention defined by the claims.

Unless otherwise indicated, all numbers expressing quantities of components, molecular weights, and so forth used in the specification and claims are to be understood as being modified in all instances by the term “about.” Accordingly, unless otherwise indicated to the contrary, the numerical parameters set forth in the specification and claims are approximations that may vary depending upon the desired properties sought to be obtained by the present invention. At the very least, and not as an attempt to limit the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. All numerical values, however, inherently contain a range necessarily resulting from the standard deviation found in their respective testing measurements.

All headings are for the convenience of the reader and should not be used to limit the meaning of the text that follows the heading, unless so specified.

What is claimed is:

1. An animal feed supplement composition comprising:
a core comprising a salt of a caustic mineral; and
free fatty acid at least partially coating the core.

2. The animal feed composition of claim 1 wherein the salt of a caustic mineral comprises potassium carbonate.

3. The animal feed supplement composition of claim 2 wherein the composition melts when heated.

4. The animal feed supplement composition of claim 1 wherein the composition melts when heated.

5. A method of making an animal feed supplement composition, the method comprising:
providing a core comprising a salt of a caustic mineral in a rotating drum;
melting a mixture of free fatty acids;
spraying the melted free fatty acid mixture on the core, thereby coating at least a portion of the core with the free fatty acid; and
allowing the free fatty acid to cool.

6. A method of reducing hygroscopy of a hygroscopic mineral salt, the method comprising:
providing a core comprising a hygroscopic mineral salt in a rotating drum;
melting a mixture of free fatty acids;
spraying the melted free fatty acid mixture on the core, thereby coating at least a portion of the core with the free fatty acid; and
allowing the free fatty acid to cool.

7. A method of reducing reactivity of a mineral salt, the method comprising:
providing a core comprising a mineral salt in a rotating drum;
melting a mixture of free fatty acids;
spraying the melted free fatty acid mixture on the core, thereby coating at least a portion of the core with the free fatty acid; and
allowing the free fatty acid to cool.
